(19) United States
(12) Patent Application Publication
(10) Pub. No.: US 2013/0297747 A1
(43) Pub. Date: Nov. 7, 2013

(54) Electronic Content Distribution System

(71) Applicant: Paul Everton, Chicago, IL (US)

(72) Inventor: Paul Everton, Chicago, IL (US)

(21) Appl. No.: 13/932,599

(22) Filed: Jul. 1, 2013

Related U.S. Application Data
(62) Division of application No. 12/916,394, filed on Oct. 29, 2010.

(51) Int. Cl. H04L 29/06

(52) U.S. Cl. CPC H04L 65/60
USPC 709/219

(57) ABSTRACT

A first computing device may send, to a second computing device, a first push notification that multimedia streaming data will be available from an identified content server. In response, the first computing device may receive an acknowledgement message sent from the second computing device, the acknowledgment message comprising a first field that includes an indicator that the second computing device will connect to the identified content server to receive said live streaming data. The first computing device may send, to said second computing device in response to the acknowledgment message, a second push notification that includes a first field that is configured to include an address associated with said identified content server. The first push notification may include a human-readable text invitation to view the live streaming multimedia data, and may comprise a calendar information.

### CLAIM OF PRIORITY

This application is a divisional of U.S. patent application Ser. No. 12/916,394 filed in response to a restriction issued on Apr. 3, 2013.

### TECHNICAL FIELD

The systems and methods disclosed and described in this document relate generally to the field of wireless electronic communications. Specifically, those systems and methods relate to the field of electronic emergency communications and notifications.

### BRIEF DESCRIPTION OF THE DRAWINGS

FIG. 1 is a system block diagram of an electronic content distribution system.

FIG. 2 is a flow diagram of a method for computing devices to create connections.

FIG. 3 is a system block diagram of a streaming media distribution system.

FIG. 4A is a flow diagram of a method of operating a content distribution system.

FIG. 4B is a flow diagram of a method of managing server resources in a content distribution system.

FIG. 5A is a block diagram of a data packet.

FIG. 5B is block diagram of a portion of the data packet illustrated in FIG. 5A.

FIG. 6 is a flow diagram of a method for choosing a content server.

FIG. 7A is a plan view of an optical storage medium.

FIG. 7B is a plan view of a magnetic storage medium.

FIG. 7C is a plan view of a removable non-volatile storage device.

FIG. 7D is a plan view of a fixed non-volatile storage device.

### SUMMARY

A method for establishing a data connection can comprise the steps of sending, from a first computing device to a second computing device, a content notification message that includes a first field that is configured to include a notification that electronic data is available from an identified content server; receiving, at the first computing device, an acknowledgement message sent from the second computing device and including a first field that is configured to include an indicator that the second computing device seeks to receive the electronic data; and sending, from the first computing device to the second computing device, an addressing message that includes a first field that is configured to include an address associated with the identified content server. The electronic data can be streaming multimedia data. The second computing device can be a mobile computing device selected from the group consisting of a laptop computer, a netbook computer, a tablet computer, a personal digital assistant, a cellular telephone, and a smartphone. The content notification message can further include a second field that is configured to include calendar information related to the electronic data. The calendar information can include calendar day information and time information.

The method can further comprise the step of selecting the identified content server from among a group of content servers. The step of selecting the identified content server can include at least one step selected from the group consisting of determining whether a server of the group of content servers has already accepted a number of data connections that is at least equal to a predetermined number of data connections, determining whether a server of the group of content servers is using an amount of available connection bandwidth that is at least equal to a predetermined level of overall bandwidth, and determining which server of the group of content servers is geographically closest to the second computing device.

A method for establishing a data connection can comprise the steps of receiving a content notification message that includes a first field configured to include a notification that electronic data is available from a content server; sending an acknowledgement message that includes a first field configured to include an indicator that a sender of the acknowledgement message seeks to receive the electronic data; and receiving an addressing message that includes a first field configured to include an address associated with the content server. The electronic data can be streaming multimedia data. The content notification message can further include a second field configured to include calendar information related to the electronic data. The calendar information can include calendar day information and time information. The method can further comprise the step of using the calendar information to create a calendar event and still further comprise the step of using the address associated with the content server to create a connection request message. The method can yet further comprise the step of sending the connection request message.

A method for establishing a data connection can comprise a step for notifying an application on a computing device that streaming electronic data is available from an identified content server; receiving an acknowledgement message configured to include an indicator that the application seeks to receive the streaming electronic data; and a step for providing an address associated with the identified content server to the application. The computing device can be a mobile computing device selected from the group consisting of a laptop computer, a netbook computer, a tablet computer, a personal digital assistant, a cellular telephone, and a smartphone.

The method can further comprise a step for providing to the computing device calendar information related to the streaming electronic data. The calendar information can include calendar day information and time information. The method can further comprise a step for selecting a server from among a group of content servers to function as the identified content server. The step for selecting a server can include at least one step selected from the group consisting of determining whether a server of the group of content servers has already accepted a number of data connections that is at least equal to a predetermined number of data connections, determining whether a server of the group of content servers is using an amount of available connection bandwidth that is at least equal to a predetermined level of overall bandwidth, and determining which server of the group of content servers is geographically closest to the second computing device.

A program storage device can be readable by a machine and can tangibly embody a program of instructions executable by the machine to perform steps in a method for facilitating establishment of a data connection between computing devices. The steps in the method can comprise sending, from a first computing device to a second computing device, a content notification message that includes a first field that is configured to include a notification that electronic data is available from an identified content server; receiving, at the first computing device, an acknowledgement message sent from the second computing device and including a first field that is configured to include an indicator that the second computing device seeks to receive the electronic data; and sending, from the first computing device to the second computing device, an addressing message that includes a first field that is configured to include an address associated with the identified content server. The electronic data can be streaming multimedia data. The second computing device can be a mobile computing device selected from the group consisting of a laptop computer, a netbook computer, a tablet computer, a personal digital assistant, a cellular telephone, and a smartphone.

The content notification message can further include a second field that is configured to include calendar information related to the electronic data. The calendar information can include calendar day information and time information. The steps in the method can further comprise the step of selecting the identified content server from among a group of content servers. The step of selecting the identified content server can include at least one step selected from the group consisting of determining whether a server of the group of content servers has already accepted a number of data connections that is at least equal to a predetermined number of data connections, determining whether a server of the group of content servers is using an amount of available connection bandwidth that is at least equal to a predetermined level of overall bandwidth, and determining which server of the group of content servers is geographically closest to the second computing device.

A program storage device can be readable by a machine and can tangibly embody a program of instructions executable by the machine to perform method steps for facilitating establishment of a data connection between computing devices. The method steps can comprise receiving a content notification message that includes a first field configured to include a notification that electronic data is available from a content server; sending an acknowledgement message that includes a first field configured to include an indicator that a sender of the acknowledgement message seeks to receive the electronic data; and receiving an addressing message that includes a first field configured to include an address associated with the content server. The electronic data can be streaming multimedia data.

The content notification message can further include a second field configured to include calendar information related to the electronic data. The calendar information can include calendar day information and time information. The method can further comprise the step of using the calendar information to create a calendar event and still further comprise the step of using the address associated with the content server to create a connection request message. The method can even still further comprise the step of sending the connection request message.

An apparatus for establishing a data connection to distribute electronic information can comprise a notification server configured to send to a remote computing device a content notification message that includes a first field configured to include a notification that electronic information is available from an identified content server; receive from the remote computing device an acknowledgement message that includes a first field configured to include an indicator that the remote computing device seeks to receive the electronic information; and send to the remote computing device an addressing message that is configured to include an address associated with the identified content server. The remote computing device can be a mobile computing device. The mobile computing device is a mobile computing device selected from the group consisting of a laptop computer, a netbook computer, a tablet computer, a personal digital assistant, a cellular telephone, and a smartphone.

The address associated with the identified content server can be an address of a load balancer. The apparatus can further comprise a load balancer configured to monitor availability of at least one content server of a group of at least two content servers. The load balancer can be further configured to monitor availability of at least one content server by monitoring at least one parameter selected from the group consisting of number of connections, amount of available network bandwidth, and geographic proximity to the mobile computing device. The load balancer can be still further configured to request additional content server resources. A request of the load balancer for additional content server resources can be configured to initiate addition of a content server to the group of at least two content servers. The request of the load balancer for additional content server resources can be configured to initiate creation of an instance of a virtual content server. The apparatus can further comprise at least one content server.

### DETAILED DESCRIPTION

Electronic content distribution systems can include the use of various network communication protocols. The devices, methods, and systems disclosed and described in this document can be used to distribute various forms of electronically formatted information, including streaming media. For ease of description, the examples included in this document focus on a distribution system arranged in a client-server architecture and sometimes reference various communication protocols that can be used in a network protocol stack model. Those of ordinary skill in this art area will recognize from reading this description that the devices, methods, and systems described can be applied to, or easily modified for use with, other types of equipment, other protocols, and at other layers in a communication protocol stack. Descriptions of components presented solely as part of a client-server architecture do not imply that other architectures, such as peer-to-peer or distributed architectures, could not be used. To the contrary, possible modifications will be apparent to people of ordinary skill in this area after reading disclosures in this document. Like reference numerals are intended to refer to the same or similar components.

Throughout this disclosure, references to components or modules generally refer to items that logically can be grouped together to perform a function or group of related functions. Components and modules can be implemented in software, hardware, or a combination of software and hardware. The term software is used expansively to include not only executable code, but also data structures, data stores and computing instructions in any electronic format, firmware, and embedded software. The term “information” is used expansively and includes a wide variety of electronic information, including but not limited to machine-executable or machine-interpretable instructions; content such as text, video data, and audio data, among others; and various codes or flags. The terms “in formation” and “content” are sometimes used interchangeably when permitted by context. It should be noted that although for clarity and to aid in understanding some examples discussed below might describe specific features or functions as part of a specific component or module, or as occurring at a specific layer of a computing device (for example, a hardware layer, operating system layer, or application layer), those features or functions may be implemented as part of a different component or module or at a different layer.

The examples discussed below are examples only and are provided to assist in the explanation of the systems and methods described. None of the features or components shown in the drawings or discussed below should be taken as mandatory for any specific implementation of any of these systems or methods unless specifically designated as mandatory. For ease of reading and clarity, certain components, modules, or methods may be described solely in connection with a specific figure. Any failure to specifically describe a combination or subcombination of components should not be understood as an indication that any combination or subcombination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented may be performed in a different order or in parallel.

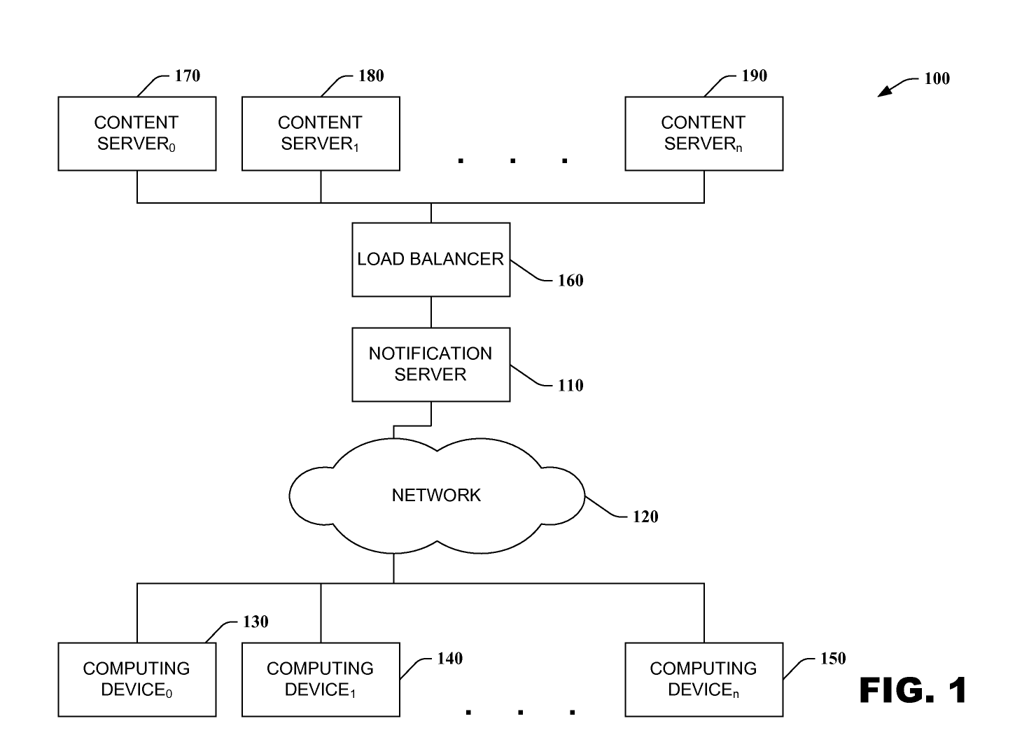

FIG. 1 is a system block diagram of an electronic content distribution system 100. A notification server 110 can accept and transmit electronic communications over a network 120. Computing devices 130, 140, 150 can connect with the notification server 110 over the network 120. A load balancer 160 can manage connections of computing devices 130, 140, 150 to content servers 170, 180, 190.

The notification server 110 can be configured to send notifications to each of the computing devices 130, 140, 150. These notifications can inform each of the computing devices 130, 140, 150 that electronic content is available for distribution to each of the computing devices 130, 140, 150. The notifications can be sent using either a “push” distribution system so that transmission of the notifications to each of the computing devices 130, 140, 150 can be initiated by the notification server 110 or, additionally or alternatively, can be sent using a “pull” distribution system so that each of the computing devices 130, 140, 150 can initiate contact with the notification system 110 to check for any available notifications.

Notification messages can be packetized and transmitted according to a number of various protocols. For ease of description, examples throughout this document are based on networks running in accordance with the transmission control protocol (‘TCP’)/Internet Protocol (“IP”) suite (the “TCP/IP suite”), the Open Systems Interconnection ('OSI”) 7-layer model, or another suitable networking protocol system. Although these examples describe notification messages originating at the application layer of the protocol stack, it should be noted that such messages can additionally or alternatively originate from processes or components operating at other layers.

Notification messages can include various types of information. Among the types contemplated here are a message indicating that electronically formatted content is available to be accessed, a message to be displayed as human-readable text, and calendar information. Calendar information can include a calendar date (for example, May 24, 2011), a start time that can indicate that the electronically formatted content can be accessed at and after that time (for example, 7:00 PM EST or 19:00:00), an epoch time that can indicate that the electronically formatted content can be accessed for a duration of time (for example, 1:00 hrs.), an end time that can indicate a time past which the electronically formatted content can no longer be accessed (for example, 8:00 PM EST or 20:00:00), and events or commands that can be used by a calendar or planner program to schedule an event.

The network 120 can be a simple network, an internetwork, or the Internet. Specifically, the network 120 can include a variety of components that can provide wired or wireless interconnections between and among a wide variety of computing devices operating on a wide variety of communication protocols. For ease of description, examples provided here assume that the network 120 is the Internet and that the protocols in use are generally those used for Internet-based communications. The mention of a specific protocol does not imply that another suitable protocol cannot be used.

Each of the computing devices 130, 140, 150 can connect to the network 120. These computing devices 130, 140, 150 can be desktop computers, mobile computing devices, specialty computers such as television set-top boxes or gaming consoles, another suitable type of computer, or any potential combination of two or more of these. If mobile computers, the computing devices 130, 140, 150 can be laptop computers, tablet computers, cellular telephones, personal digital assistants, smartphones, another suitable type of mobile computing device, or any potential combination of these.

The load balancer 160 can manage requests to connect to the content servers 170, 180, 190 that can be sent by the computing devices 130, 140, 150 over the network 120. Specifically, the load balancer 160 can accept all requests from computing devices 130, 140, 150 to connect to one of the content servers 170, 180, 190; determine which of the content servers 170, 180, 190 is available to accept a new connection; and provide the address of the available server to the requesting device of the computing devices 130, 140, 150.

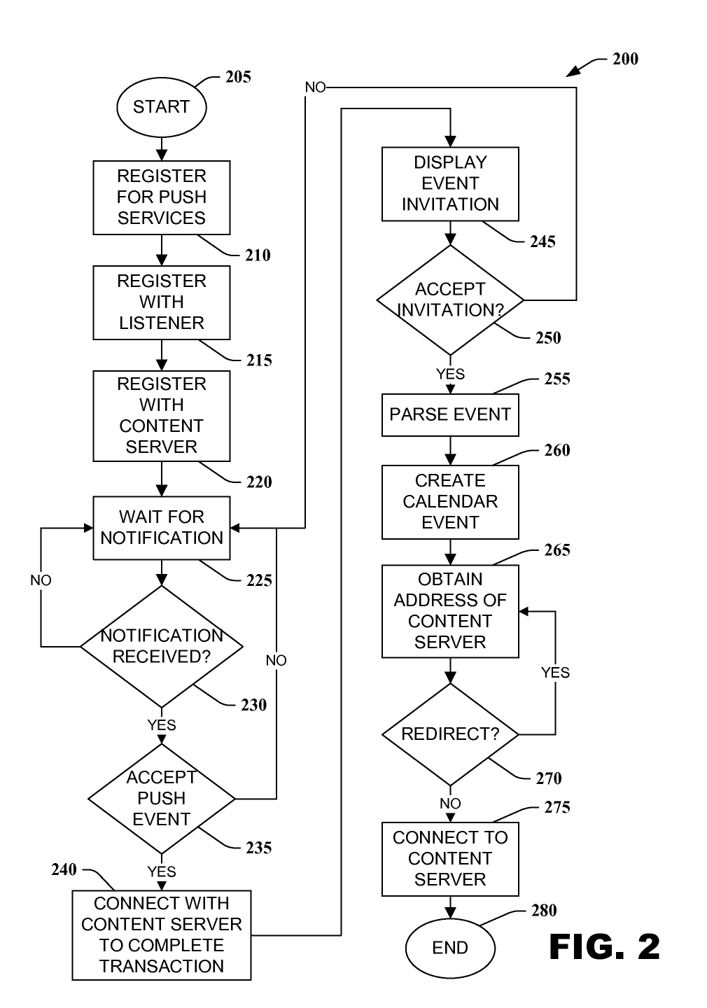

FIG. 2 is a flow diagram of a method 200 for computing devices to create connections. Execution of the method 200 begins at START block 205 and continues to process block 210 where a computing device, such as a mobile computing device or smartphone, registers for push services with a registration server. Depending upon specifics of the device registering for push services, the actual registration request may come from hardware in the device, from a component of low-level software such as an operating system, or from an application running at a higher level on the device.

Processing continues at process block 215 where the computing device registers with a listener. As with the previous step, the actual registration request may come from hardware in the device, from a component of low-level software such as an operating system, or from an application running at a higher level on the device. In this specific example, the listener can be part of a software application running at the application level on a computing device. However, the listener can also be a component or process at a different level, including the operating system level or a hardware component.

At process block 225, the application waits to receive a notification pushed to it from a push notification server. The application makes a determination at decision block 230 whether a notification has been received. If that determination is NO, processing resumes at process block 225. If the determination is YES, processing continues to decision block 235 where a determination is made whether to accept the notification. If that determination is NO, processing resumes at process block 225. If YES, processing continues to process block 240.

At process block 240, the application connects to the push server to complete receipt of the pushed notification. It should be noted that this step can be performed when targeting devices that have limitations in their ability to receive push notifications and can engage in multi-step processes to receive all of the content of a notification. This step is optional for devices that can receive the entire content of a notification message in a single step.

Processing continues to process block 245 where the device displays an event invitation message, typically in the form of a human-readable message. At decision block 250, a determination is made whether the computing device will accept the invitation. Various mechanisms of determining acceptance can be used, including detection of selection of a hardware or on-screen button, or through another suitable approach. If the determination is NO, processing returns to process block 225. If the determination is YES, processing continues to process block 255.

At process block 255, content of the notification message is parsed to identify and access any calendar data included with the pushed notification message along with an address associated with a content server that the computing device can contact to obtain electronically formatted content, such as streaming media content. That calendar data is used to create a calendar event in a calendar application of the computing device at process block 260. The calendar event can then serve as a notification or reminder of availability of electronically formatted content.

Processing continues to process block 265 where the computing device uses the address of the content server obtained from the notification message to contact the content server. It should be noted that the address can be in a variety of formats. Specifically, the address can be in the form of a machine address or a human-understandable address, including formats recognized by the Internet Corporation for Assigned Names and Numbers (“ICANN”). A machine address can be in the form of version 4 or version 6 of the Internet Protocol or another appropriate address format. A human-understandable address can be in the form of a partial or fully-qualified uniform resource locator (“URL”) or domain name in accordance with formats used in the domain name system (“DNS”). It should be noted that the address associated with the content server can be an address of a load balancer that can provide a second address of another machine that can actually provide the electronically formatted content.

At decision block 270, a determination is made whether the connection of the computing device to the content server is to be redirected, as when an address of a load balancer is the address initially provided to the computing device. Redirection can be accomplished using the REDIRECT command available in the hypertext transmission protocol (“HTTP”). If the determination is YES, processing returns to process block 265 where an address of a content server is obtained. If the determination is NO, processing continues to process block 275 where the computing device connects to the content server. Processing terminates at END block 280.

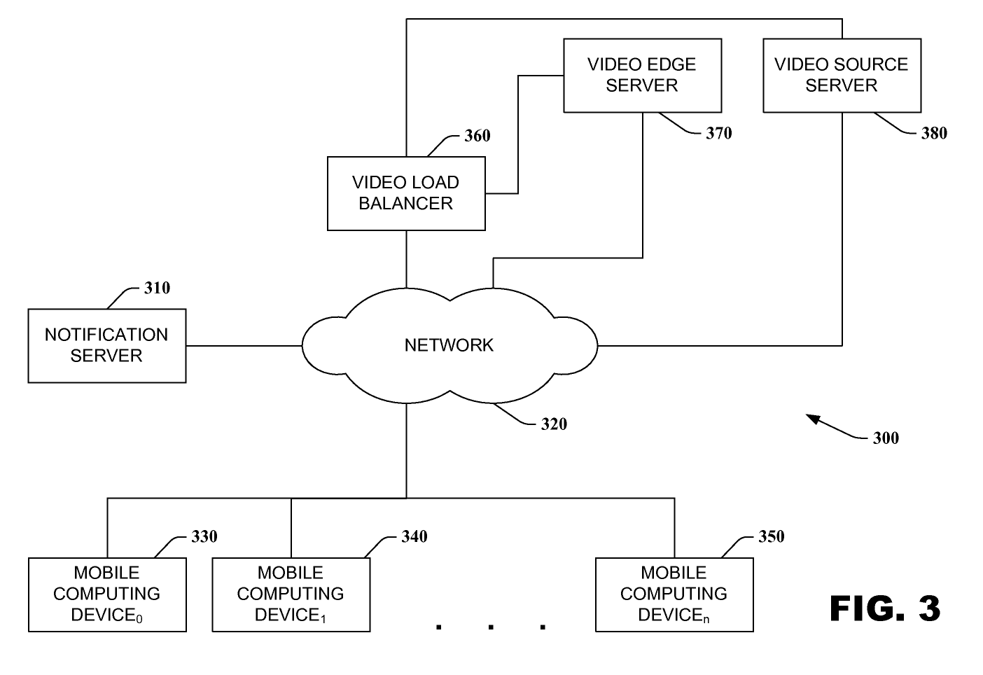

FIG. 3 is a system block diagram of a streaming media distribution system 300. The streaming media distribution system 300 can include a notification server 310 that can connect to a network 320. Mobile computing devices 330, 340, 350 can also connect to the network 320. A video load balancer 360 can connect to the network 320 as well as to other servers, including a video edge server 370 and a video source server 380.

The notification server 310 can push notifications of availability of electronically formatted content, such as a streaming video event, over the network 320 to each of the mobile computing devices 330, 340, 350. For those devices that cannot accept larger-sized push notification messages, the notification server can provide a two-stage notification as previously discussed. Each of the mobile computing devices 330, 340, 350 can use an address from the pushed notification message to contact the video load balancer 360. The video load balancer 360 can provide an address of an available video server, in this example, the video edge server 370, to each of the mobile computing devices 330, 340, 350. It should be noted that each of the mobile computing devices 330, 340, 350 can obtain a different address of a different video edge server as the video load balancer 360 manages server resources.

The video edge server 370 can provide different forms of the electronically formatted content to each of the mobile computing devices 330, 340, 350 by using techniques such as identification of operating systems and other software on the mobile computing devices 330, 340, 350 and stream splitting, among others. Distribution and transport of the electronically formatted information to the mobile computing devices 330, 340, 350 by the video edge server can be in accordance with protocols supported by the network 320. These protocols can include file transfer protocol (“FTP”), real time streaming protocol (“RTSP”), real time messaging protocol (“RTMP”), HTTP, TCP/IP, and user datagram protocol (“UDP”), among others.

The video source server 380 can function as the initial origin of the electronically formatted content and can deliver that electronically formatted content to the video edge server 370 for further distribution over the network 320 to the mobile computing devices 330, 340, 350. The format of the electronically formatted content provided by the video source server 380 can be different from the format ultimately sent to the mobile computing devices 330, 340, 350 by the video edge server 370. Conversion into other formats can be accomplished by the video source server 380, the video edge server 370, or a conversion server (not shown).

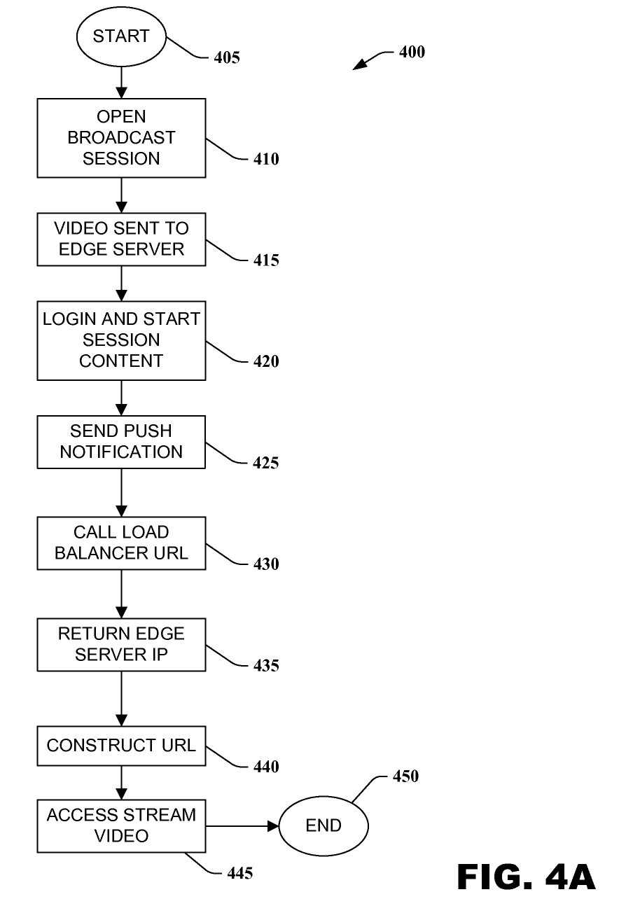

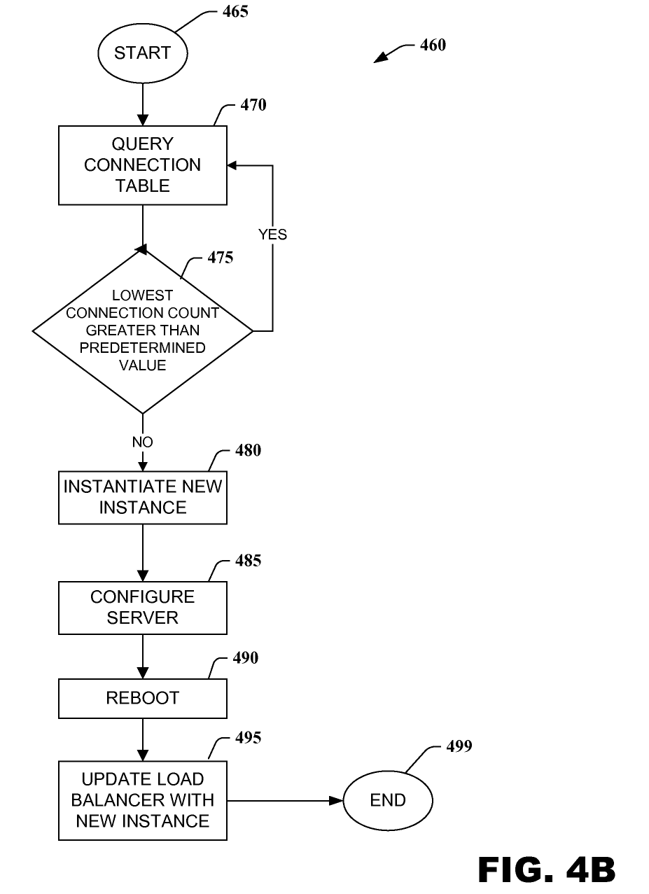

FIG. 4 is a flow diagram of a method 400 of operating a content distribution system. Specifically, the method 400 can be used to operate a live webcast that includes streaming video. Execution of the method begins at START block 405 and continues to process block 410 where a broadcast session is initiated using preconfigured parameters. At process block 410, video data is sent from a source server to an edge server.

Processing continues at process block 420 where a creator of the streaming video logs in and begins the streaming session. At process block 425 a push notification is sent to potential recipients of the video stream. Those potential recipients that are to actually receive the video stream use the URL provided in the push notification to contact a load balancer at process block 430. Processing continues at process block 435 where the load balancer returns an edge server IP address for the recipient to use to access the streaming video. At process block 440 the recipient constructs a URL. The recipient accesses the streaming video at process block 445. Processing of the method 400 terminates at END block 450.

FIG. 4B is a flow diagram of a method 460 of managing server resources in a content distribution system. Execution of the method 460 begins at START block 465 and continues to process block 470 where a server connection table is queried. At decision block 475 a determination is made whether the lowest connection count is greater than a predetermined limit. If YES, processing returns to process block 470. If NO, processing continues to process block 480 where a new instance of a virtual server is instantiated. Additionally or alternatively, a physical server can be brought on-line.

At process block 485, the new server is configured using a configuration file. The configured server is rebooted at process block 490. Processing continues at process block 495 where the load balancer server and connection tables are updates with information from the new server. Processing terminates at END block 499.

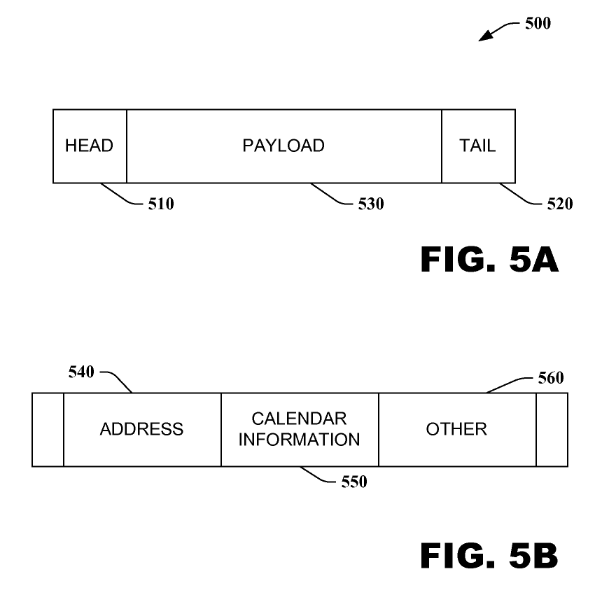

FIG. 5A is a block diagram of a data packet 500. The data packet 500 can be used in the transmission of pushed notification messages and can include multiple data fields, including a head 510, a tail 520, and a payload or body 530. Other potential fields and subfields are not shown. Those having an ordinary level of skill in this area will recognize that data packets such as the data packet 510 can contain messages from other layers in the TCP/IP stack and can be constructed in a variety of formats according to various application or protocol considerations. In accordance with a variety of transport protocols that can be used here, including TCP/IP, the head 510 and the tail 520 can each include addressing information. The payload 530 can include information that can originate from processes at higher levels in the protocol stack.

FIG. 5B is block diagram of a portion of the data packet illustrated in FIG. 5A, specifically, of a portion of the payload 530. This portion can include several data fields, such as an address field 540 and calendar information field 550. Other data can be placed in fields or subfields in the other field 560. The address field 540 can include an address of a content server. The calendar information field 550 can include calendar information related to availability of electronically formatted content from a content server.

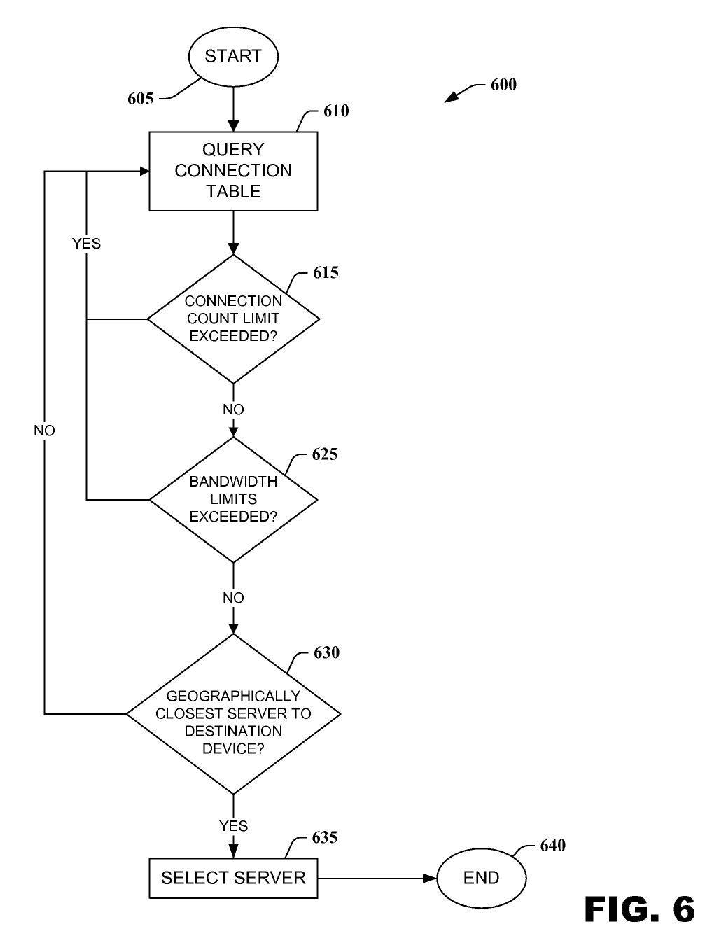

FIG. 6 is a flow diagram of a method 600 for choosing a content server. Execution of the method 600 begins at START block 605 and continues to process block 610 where a connection table is queried. At decision block 615, a determination is made whether a server already has in excess of a predetermined number of connections made. If YES, processing returns to process block 610. If NO, processing continues to decision block 625 where a determination is made whether a server's bandwidth limits have been exceeded. If YES, processing returns to process block 610. If NO, processing continues to decision block 630 where a determination is made whether a server is geographically closest to a geographic location of a device that will receive data from that server. If NO, processing returns to process block 610. If YES, processing continues to process block 635 where a server is selected. Processing terminates at END block 640. It should be noted that each of the determinations made can be used on its own so that upon a NO determination from decision block 615 or decision block 625, processing would continue to process block 635.

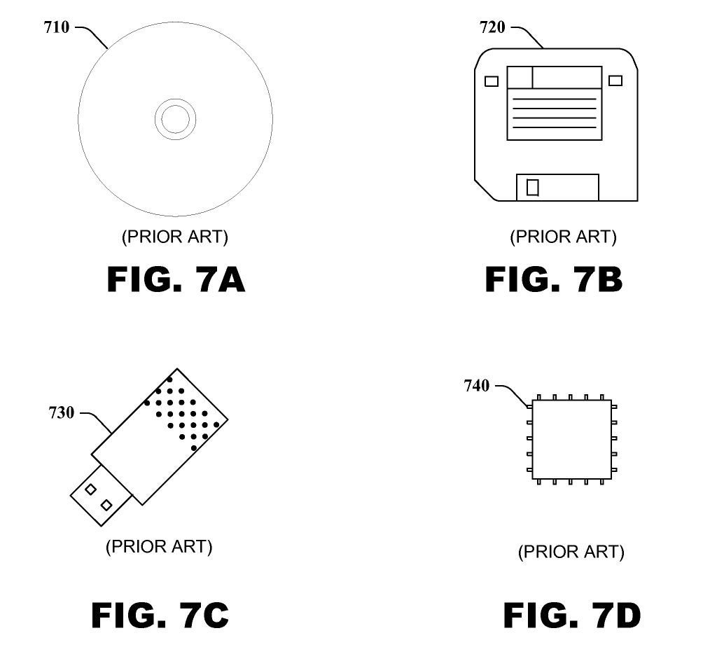

FIG. 7A is a plan view of an optical storage device 710. The optical storage device 710 can provide computer-readable, non-volatile storage for computer-executable instructions in the form of software. Typically, the optical storage device 710 can be formatted in a variety of ways consistent with particulars of its physical structure, including formatting in accordance with versions of a variety of specifications, including as a compact disk (“CD”), a digital versatile disk (“DVD”), a high-density digital versatile disk (“HD-DVD”), or as a Blu-Ray disk, among others.

FIG. 7B is a plan view of a magnetic storage medium 720. Although depicted as a floppy disk, the magnetic storage medium 720 can also be any storage medium that can persistently store computer program instructions through encoded signals on a magnetically-responsive surface. Devices of this type can include magnetic tapes and hard disk drives, including multi-platter disk drives.

FIG. 7C is a plan view of a removable non-volatile storage device 730. As shown, the removable non-volatile storage device 730 can be a flash drive that can connect to a computing device through a universal serial bus (“USB”) connection interface. The removable non-volatile storage device 730 can also be another of a variety of suitable storage devices, including flash memory storage constructed as a Compact Flash®, Memory Stick®, Secure Digital (“SD”), miniSD, microSD, or eXtreme Digital (“XD”) device, among others.

FIG. 7D is a plan view of a fixed non-volatile storage device 740. The fixed non-volatile storage device 740 can be a memory chip that includes flash memory components or electrically erasable programmable read-only memory (“EEPROM”) components. The fixed non-volatile storage device 740 can be a non-removable component of a computing device. Typically, flash memory components or EEPROMs can be permanently included in computing devices to store computer-executable instructions in the form of software or firmware.

The above descriptions of various components and methods are intended to illustrate specific examples and describe certain ways of making and using the devices disclosed and described here. These descriptions are neither intended to be nor should be taken as an exhaustive list of the possible ways in which these components can be made and used. A number of modifications, including substitutions of components between or among examples and variations among combinations can be made. Those modifications and variations should be apparent to those of ordinary skill in this area after having read this document.

What is claimed is:

1. A method for establishing a data connection, said method comprising:
sending, from a first computing device to a second computing device, a content notification message that live multimedia streaming data will be available from an identified content server;
receiving, at said first computing device, an acknowledgement message sent from said second computing device in response to said content notification message, said acknowledgment message including a first field that includes an indicator that said second computing device will connect to said identified content server to receive said live streaming data; and
sending, from said first computing device to said second computing device in response to said acknowledgment message, an addressing message that includes a first field that includes an address associated with said identified content server.

2. Said method of claim 1, wherein:
said first message is a push notification;
said push notification comprises a human-readable text invitation to view said live streaming multimedia data; and
a second field of said first message includes calendar information including a start time of said live streaming multimedia data.

3. Said method of claim 2, wherein said calendar information includes a stop time of said live streaming multimedia data.

4. Said method of claim 3, wherein said calendar information includes a duration of said live streaming multimedia data.

5. Said method of claim 2, wherein said calendar information includes one or more commands for creating a calendar event corresponding to said live streamlining multimedia data in a calendar application of said second computing device.

6. Said method of claim 1, further comprising selecting said identified content server from among a group of content servers.

7. Said method of claim 6, wherein said selecting said identified content server includes at least one of:
determining whether a server of said group of content servers has already accepted a number of data connections that is at least equal to a predetermined number of data connections; and
determining whether a server of said group of content servers is using an amount of available connection bandwidth that is at least equal to a predetermined level of overall bandwidth.

8. Said method of claim 6, wherein the said selecting said identified content server comprises determining which server of the group of content servers is geographically closest to the second computing device.

9. A method performed in a computing device, said method comprising:
receiving a first message that includes a first field configured to include a notification that live streaming multimedia data will be available from an identified content server;
in response to a determination to consume said live streaming multimedia data, sending an acknowledgement message that includes a first field configured to include an indicator that said computing device will connect to said identified content server to receive said live streaming multimedia data; and
receiving an addressing message that includes a first field that is configured to include an address associated with said identified content server.

10. Said method of claim 9, wherein:
said first message is a push notification message;
said push notification comprises a human-readable text invitation to view said live streaming multimedia data; and
a second field of said first message includes calendar information including a start time of said live streamlining multimedia.

11. Said method of claim 10, wherein said calendar information includes a stop time of said live streaming multimedia data.

12. Said method of claim 10, wherein said calendar information includes a duration of said live streaming multimedia data.

13. Said method of claim 10, wherein said calendar information includes one or more commands for creating a calendar event corresponding to said live streamlining multimedia data in a calendar application of said computing device, and comprising:
using said commands to create a calendar event in response to said determination to consume said live streamlining multimedia data.

14. Said method of claim 13, further comprising using said address associated with said identified content server-to create a connection request message.

15. Said method of claim 14, further comprising sending said connection request message.

16. Said method of claim 9, further comprising using said address associated with said content server to create a connection request message.

17. Said method of claim 16, further comprising sending said connection request message.

18. A System comprising:
a first computing device configured to:
send, to a second computing device, a first push notification that multimedia streaming data will be available from an identified content server;
receive an acknowledgement message sent from said second computing device in response to said first push notification, said acknowledgment message including a first field that includes an indicator that said second computing device will connect to said identified content server to receive said live streaming data; and
send, to said second computing device in response to said acknowledgment message, a second push notification that includes a first field that includes an address associated with said identified content server.

19. Said system of claim 18, wherein:
said first push notification comprises a human-readable text invitation to view said live streaming multimedia data; and
a second field of said first push notification includes calendar information including a start time of said live streaming multimedia data.

20. Said system of claim 19, wherein said calendar information includes one or more commands for creating a calendar event corresponding to said live streamlining multimedia data in a calendar application of said second computing device.
